(19) United States
(12) Patent Application Publication
(10) Pub. No.: US 2018/0188838 A1
(43) Pub. Date: Jul. 5, 2018

(54) METHOD OF DISPOSING TOUCH SENSOR FOR ENHANCING TOUCH ACCURACY AND ELECTRONIC DEVICE USING THE SAME

(71) Applicant: Samsung Electronics Co., Ltd., Suwon-si (KR)

(72) Inventors: Jungchul AN, Yongin-si (KR); Junghoon PARK, Incheon (KR); Kyongrok KANG, Suwon-si (KR); Donghun KIM, Seoul (KR); Jongkon BAE, Seoul (KR); Joungmin CHO, Seoul (KR); Kwangtai KIM, Suwon-si (KR); Hyungsup BYEON, Suwon-si (KR)

(21) Appl. No.: 15/811,366

(22) Filed: Nov. 13, 2017

(30) Foreign Application Priority Data
Jan. 3, 2017 (KR) 10-2017-0000788

(51) Int. Cl. G06F 3/0354; G06F 3/041; G06F 3/044; H01Q 1/24; H04B 5/00

(52) U.S. Cl. CPC G06F 3/03547; G06F 3/0412; H04B 5/0031; H01Q 1/243; G06F 3/044

(57) ABSTRACT

A method of disposing a touch sensor for enhancing touch accuracy and an electronic device using the same. The electronic device includes a housing including a first surface forming an outer surface of the electronic device and a second surface of a direction different from that of the first surface; and a first touch sensor and second touch sensor disposed at a first designated gap at the first surface, and at least one third touch sensor disposed at a second designated gap from the first touch sensor at the second surface. Various exemplary embodiments may be further included.

### CROSS-REFERENCE TO RELATED APPLICATIONS AND CLAIM OF PRIORITY

This application is related to and claims priority to Korean Application No. 10-2017-0000788 filed on Jan. 3, 2017, the contents of which are incorporated herein by reference.

### TECHNICAL FIELD

The present disclosure relates to a method of disposing a touch sensor for enhancing touch accuracy and an electronic device using the same.

### BACKGROUND

Electronic devices may be configured such that a display includes a touch screen; thus, a user can input a touch to an object displayed on a screen.

By configuring a display into a flexible display, technology has been introduced that extends a display screen of the display to a side surface or a rear surface as well as a front surface of the electronic device, and a portion of the technology has been applied to the electronic device.

In an electronic device using a flexible display, as the display is extended from a front surface of the electronic device to a side surface thereof, an image is displayed even at the side surface of the electronic device and a touch may be input thereto. However, in the electronic device, because a resolution of a touch sensor constituting a touch screen is uniform, there is a problem that user unintended touch detection occurs in an area in which the touch screen and a display are bent.

### SUMMARY

To address the above-discussed deficiencies, it is a primary object to provide an electronic device having a touch screen that can prevent user unintended touch detection from occurring in an area in which a touch screen and a display are bent.

In accordance with an aspect of the present disclosure, an electronic device includes a housing including a first surface forming an outer surface of the electronic device and a second surface of a direction different from that of the first surface; and a first touch sensor and second touch sensor disposed at a first designated gap at the first surface, and at least one third touch sensor disposed at a second designated gap from the first touch sensor at the second surface.

In accordance with another aspect of the present disclosure, an electronic device includes a housing including a first surface and a second surface of a direction different from that of the first surface; and a touch screen including a first touch sensor array disposed at the first surface and a second touch sensor array disposed at the second surface, wherein a separation distance between the first and second touch sensor arrays is different from that between touch sensors constituting the first touch sensor array.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram illustrating a configuration of an electronic device in a network environment according to various exemplary embodiments;

FIG. 2 illustrates a block diagram illustrating a configuration of an electronic device according to various exemplary embodiments;

FIG. 3 illustrates a block diagram illustrating a configuration of a program module according to various exemplary embodiments;

FIG. 4 illustrates a cross-sectional view illustrating an electronic device according to an exemplary embodiment of the present disclosure;

FIG. 5 illustrates a cross-sectional view illustrating an electronic device according to another exemplary embodiment of the present disclosure;

FIG. 6 illustrates a top plan view illustrating a touch screen according to an exemplary embodiment of the present disclosure;

FIG. 7 illustrates a diagram illustrating a connection wiring of a touch screen according to an exemplary embodiment of the present disclosure;

FIG. 8 illustrates a diagram illustrating a bending area of a touch screen according to an exemplary embodiment of the present disclosure;

FIG. 9 illustrates a diagram illustrating a configuration of a touch screen according to another exemplary embodiment of the present disclosure;

FIG. 10 illustrates an enlarged cross-sectional view illustrating a portion of an electronic device according to various exemplary embodiments of the present disclosure;

FIG. 11 illustrates a cross-sectional view illustrating a pressure sensor according to an exemplary embodiment of the present disclosure;

FIG. 12 illustrates a top plan view illustrating a first electrode layer of a pressure sensor according to an exemplary embodiment of the present disclosure;

FIG. 13 illustrates a diagram illustrating an antenna formed in a touch screen according to an exemplary embodiment of the present disclosure;

FIG. 14 illustrates a diagram illustrating an example of using a portion of a touch screen as an antenna according to an exemplary embodiment of the present disclosure;

FIG. 15 illustrates a diagram illustrating driving timing of a touch screen according to an exemplary embodiment of the present disclosure;

FIG. 16 illustrates a diagram illustrating an example of using a portion of a touch screen as an antenna according to an exemplary embodiment of the present disclosure; and

FIG. 17 illustrates a diagram illustrating an example of using a portion of a touch screen as an antenna according to another exemplary embodiment of the present disclosure.

### DETAILED DESCRIPTION

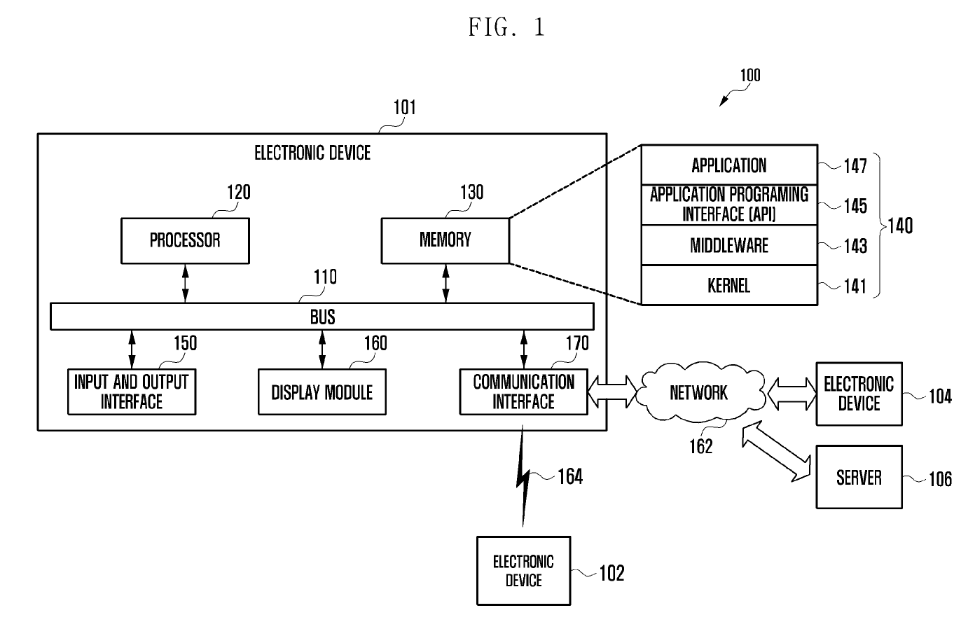

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The expressions such as “include” and “may include” may denote the presence of the disclosed functions, operations, and constituent elements and do not limit one or more additional functions, operations, and constituent elements. Terms such as “include” and/or “have” may be construed to denote a certain characteristic, number, operation, constituent element, component or a combination thereof, but may not be construed to exclude the existence of or a possibility of addition of one or more other characteristics, numbers, operations, constituent elements, components or combinations thereof.

Furthermore, in the present disclosure, the expression “and/or” includes any and all combinations of the associated listed words. For example, the expression “A and/or B” may include A, may include B, or may include both A and B.

In the present disclosure, expressions including ordinal numbers, such as “first” and “second,” etc., may modify various elements. However, such elements are not limited by the above expressions. For example, the above expressions do not limit the sequence and/or importance of the elements. The above expressions are used merely for the purpose to distinguish an element from the other elements. For example, a first user device and a second user device indicate different user devices although both of them are user devices. For example, a first element could be termed a second element, and similarly, a second element could be also termed a first element without departing from the scope of the present disclosure.

In the case where a component is referred to as being “connected” or “accessed” to other component, it should be understood that not only the component is directly connected or accessed to the other component, but also there may exist another component between them. Meanwhile, in the case where a component is referred to as being “directly connected” or “directly accessed” to other component, it should be understood that there is no component therebetween. The terms used in the present disclosure are only used to describe specific various embodiments, and are not intended to limit the present disclosure. As used herein, the singular forms are intended to include the plural forms as well, unless the context clearly indicates otherwise. Singular forms are intended to include plural forms unless the context clearly indicates otherwise.

An electronic device according to the present disclosure may be a device including a communication function. For example, the device corresponds to a combination of at least one of a smartphone, a tablet personal computer (PC), a mobile phone, a video phone, an e-book reader, a desktop PC, a laptop PC, a netbook computer, a personal digital assistant (PDA), a portable multimedia player (PMP), a digital audio player, a mobile medical device, an electronic bracelet, an electronic necklace, an electronic accessory, a camera, a wearable device, an electronic clock, a wrist watch, home appliances (for example, an air-conditioner, vacuum, an oven, a microwave, a washing machine, an air cleaner, and the like), an artificial intelligence robot, a television (TV), a digital video disk (DVD) player, an audio device, various medical devices (for example, magnetic resonance angiography (MRA), magnetic resonance imaging (MRI), computed tomography (CT), a scanning machine, a ultrasonic wave device, or the like), a navigation device, a global positioning system (GPS) receiver, an event data recorder (EDR), a Flight data recorder (FDR), a set-top box, a TV box (for example, SAMSUNG HOMESYNC™, APPLE TV™, or GOOGLE TV™), an electronic dictionary, vehicle infotainment device, an electronic equipment for a ship (for example, navigation equipment for a ship, gyrocompass, or the like), avionics, a security device, electronic clothes, an electronic key, a camcorder, game consoles, a head-mounted display (HMD), a flat panel display device, an electronic frame, an electronic album, furniture or a portion of a building/structure that includes a communication function, an electronic board, an electronic signature receiving device, a projector, and the like. It is obvious to those skilled in the art that the electronic device according to the present disclosure is not limited to the aforementioned devices.

FIG. 1 illustrates a block diagram illustrating a configuration of an electronic device according to an embodiment of the present disclosure.

With reference to FIG. 1, the electronic device 100 may include a bus 110, a processor 120, a memory 130, a user input module 150, a display module 160, a communication interface 170, and other similar and/or suitable components.

The bus 110 may be a circuit that interconnects the above-described elements and delivers a communication (e.g., a control message) between the above-described elements.

The processor 120 may receive commands from the above-described other elements (e.g., the memory 130, the user input module 150, the display module 160, the communication interface 170, etc.) through the bus 110, may interpret the received commands, and may execute calculation or data processing according to the interpreted commands.

The memory 130 may store commands or data received from the processor 120 or other elements (e.g., the user input module 150, the display module 160, the communication interface 170, etc.) or generated by the processor 120 or the other elements. The memory 130 may include programming modules, such as a kernel 141, middleware 143, an application programming interface (API) 145, an application 147, and the like. Each of the above-described programming modules may be implemented in software, firmware, hardware, or a combination of two or more thereof.

The kernel 141 may control or manage system resources (e.g., the bus 110, the processor 120, the memory 130, etc.) used to execute operations or functions implemented by other programming modules 140 (e.g., the middleware 143, the API 145, and the application 147). Also, the kernel 141 may provide an interface capable of accessing and controlling or managing the individual elements of the electronic device 100 by using the middleware 143, the API 145, or the application 147.

The middleware 143 may serve to go between the API 145 or the application 147 and the kernel 141 in such a manner that the API 145 or the application 147 communicates with the kernel 141 and exchanges data therewith. Also, in relation to work requests received from one or more applications 147 and/or the middleware 143, for example, may perform load balancing of the work requests by using a method of assigning a priority, in which system resources (e.g., the bus 110, the processor 120, the memory 130, etc.) of the electronic device 100 can be used, to at least one of the one or more applications 147.

The API 145 is an interface through which the application 147 is capable of controlling a function provided by the kernel 141 or the middleware 143, and may include, for example, at least one interface or function for file control, window control, image processing, character control, or the like.

The user input module 150, for example, may receive a command or data as input from a user, and may deliver the received command or data to the processor 120 or the memory 130 through the bus 110. The display module 160 may display a video, an image, data, or the like to the user.

The communication interface 170 may connect communication between another electronic device 102 and the electronic device 100. The communication interface 170 may support a predetermined short-range communication protocol (e.g., Wi-Fi, BLUETOOTH (BT), and near field communication (NFC)), or predetermined network 162 communication (e.g., the Internet, a local area network (LAN), a wide area network (WAN), a telecommunication network, a cellular network, a satellite network, a plain old telephone service (POTS), or the like). Each of the electronic devices 102 and 104 may be a device that is identical (e.g., of an identical type) to or different (e.g., of a different type) from the electronic device 100. Further, the communication interface 170 may connect communication between a server 106 and the electronic device 100 via the network 162.

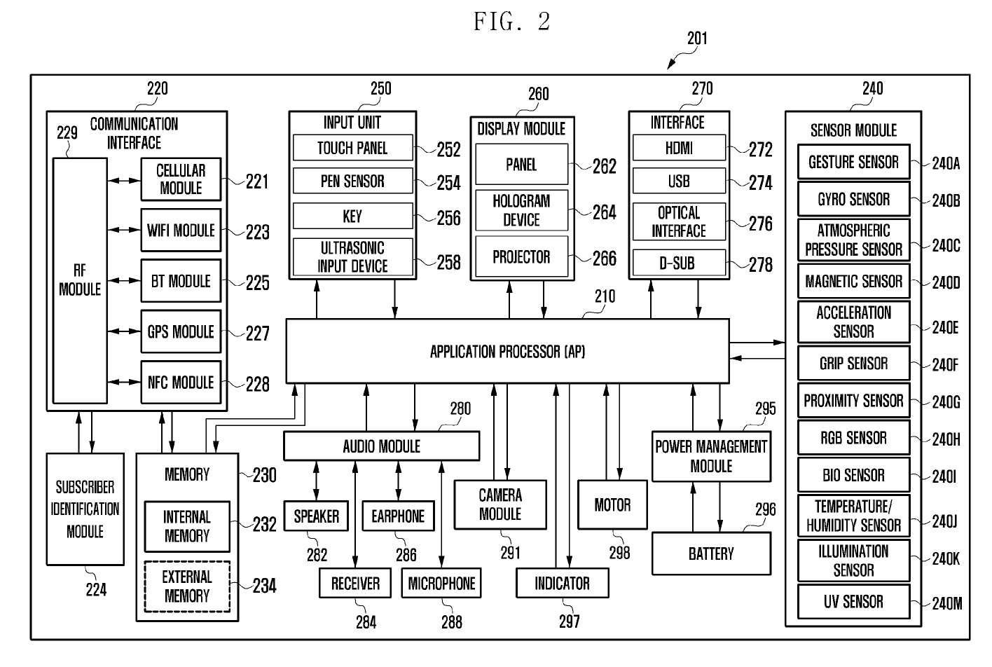

FIG. 2 illustrates a block diagram illustrating a configuration of an electronic device 201 according to an embodiment of the present disclosure.

The hardware may be, for example, the electronic device 101 illustrated in FIG. 1.

With reference to FIG. 2, the electronic device may include one or more processors 210, a communication interface 220, a subscriber identification module (SIM) card 224, a memory 230, a sensor module 240, a input device 250, a display module 260, an interface 270, an audio module 280, a camera module 291, a power management module 295, a battery 296, an indicator 297, a motor 298 and any other similar and/or suitable components.

The application processor (AP) 210 (e.g., the processor 120) may include one or more application processors (APs), or one or more communication processors (CPs). The application processor 210 may be, for example, the processor 120 illustrated in FIG. 1. The AP 210 is illustrated as being included in the application processor 210 in FIG. 2, but may be included in different integrated circuit (IC) packages, respectively. According to an embodiment of the present disclosure, the AP 210 may be included in one IC package.

The AP 210 may execute an operating system (OS) or an application program, and thereby may control multiple hardware or software elements connected to the AP 210 and may perform processing of and arithmetic operations on various data including multimedia data. The AP 210 may be implemented by, for example, a system on chip (SoC). According to an embodiment of the present disclosure, the AP 210 may further include a graphical processing unit (GPU) (not illustrated).

The AP 210 may manage a data line and may convert a communication protocol in the case of communication between the electronic device (e.g., the electronic device 100) including the hardware 200 and different electronic devices connected to the electronic device through the network. The AP 210 may be implemented by, for example, a SoC. According to an embodiment of the present disclosure, the AP 210 may perform at least some of multimedia control functions. The AP 210, for example, may distinguish and authenticate a terminal in a communication network by using a subscriber identification module (e.g., the SIM card 224). Also, the AP 210 may provide the user with services, such as a voice telephony call, a video telephony call, a text message, packet data, and the like.

Further, the AP 210 may control the transmission and reception of data by the communication interface 220. In FIG. 2, the elements such as the AP 210, the power management module 295, the memory 230, and the like are illustrated as elements separate from the AP 210. However, according to an embodiment of the present disclosure, the AP 210 may include at least some (e.g., the CP) of the above-described elements.

According to an embodiment of the present disclosure, the AP 210 may load, to a volatile memory, a command or data received from at least one of a non-volatile memory and other elements connected to each of the AP 210, and may process the loaded command or data. Also, the AP 210 may store, in a non-volatile memory, data received from or generated by at least one of the other elements.

The SIM card 224 may be a card implementing a subscriber identification module, and may be inserted into a slot formed in a particular portion of the electronic device 100. The SIM card 224 may include unique identification information (e.g., integrated circuit card identifier (ICCID)) or subscriber information (e.g., international mobile subscriber identity (IMSI)).

The memory 230 may include an internal memory 232 and an external memory 234. The memory 230 may be, for example, the memory 130 illustrated in FIG. 1. The internal memory 232 may include, for example, at least one of a volatile memory (e.g., a dynamic RAM (DRAM), a static RAM (SRAM), a synchronous dynamic RAM (SDRAM), etc.), and a non-volatile memory (e.g., a one time programmable ROM (OTPROM), a programmable ROM (PROM), an erasable and programmable ROM (EPROM), an electrically erasable and programmable ROM (EEPROM), a mask ROM, a flash ROM, a Not AND (NAND) flash memory, a Not OR (NOR) flash memory, etc.). According to an embodiment of the present disclosure, the internal memory 232 may be in the form of a solid state drive (SSD). The external memory 234 may further include a flash drive, for example, a compact flash (CF), a secure digital (SD), a micro-secure digital (Micro-SD), a mini-secure digital (Mini-SD), an extreme digital (xD), a memory stick, or the like.

The communication interface 220 may include a cellular module 221, a wireless communication module 223 or a radio frequency (RF) module 229. The communication interface 220 may be, for example, the communication interface 170 illustrated in FIG. 1. The communication interface 220 may include, for example, a Wi-Fi part 223, a BT part 225, a GPS part 227, or a NFC part 228. For example, the wireless communication module 223 may provide a wireless communication function by using a radio frequency. Additionally or alternatively, the wireless communication module 223 may include a network interface (e.g., a LAN card), a modulator/demodulator (modem), or the like for connecting the hardware 200 to a network (e.g., the Internet, a LAN, a WAN, a telecommunication network, a cellular network, a satellite network, a POTS, or the like).

The RF module 229 may be used for transmission and reception of data, for example, transmission and reception of RF signals or called electronic signals. Although not illustrated, the RF module 229 may include, for example, a transceiver, a power amplifier module (PAM), a frequency filter, a low noise amplifier (LNA), or the like. Also, the RF module 229 may further include a component for transmitting and receiving electromagnetic waves in a free space in a wireless communication, for example, a conductor, a conductive wire, or the like.

The sensor module 240 may include, for example, at least one of a gesture sensor 240A, a gyro sensor 240B, an barometer sensor 240C, a magnetic sensor 240D, an acceleration sensor 240E, a grip sensor 240F, a proximity sensor 240G, a red, green and blue (RGB) sensor 240H, a biometric sensor 240I, a temperature/humidity sensor 240J, an illuminance sensor 240K, and a ultra violet (UV) sensor 240M. The sensor module 240 may measure a physical quantity or may sense an operating state of the electronic device 100, and may convert the measured or sensed information to an electrical signal. Additionally/alternatively, the sensor module 240 may include, for example, an E-nose sensor (not illustrated), an electromyography (EMG) sensor (not illustrated), an electroencephalogram (EEG) sensor (not illustrated), an electrocardiogram (ECG) sensor (not illustrated), a fingerprint sensor (not illustrated), and the like. Additionally or alternatively, the sensor module 240 may include, for example, an E-nose sensor (not illustrated), an EMG sensor (not illustrated), an EEG sensor (not illustrated), an ECG sensor (not illustrated), a fingerprint sensor, and the like. The sensor module 240 may further include a control circuit (not illustrated) for controlling one or more sensors included therein.

The input device 250 may include a touch panel 252, a pen sensor 254 (e.g., a digital pen sensor), keys 256, and an ultrasonic input unit 258. The input device 250 may be, for example, the user input module 150 illustrated in FIG. 1. The touch panel 252 may recognize a touch input in at least one of, for example, a capacitive scheme, a resistive scheme, an infrared scheme, and an acoustic wave scheme. Also, the touch panel 252 may further include a controller (not illustrated). In the capacitive type, the touch panel 252 is capable of recognizing proximity as well as a direct touch. The touch panel 252 may further include a tactile layer (not illustrated). In this event, the touch panel 252 may provide a tactile response to the user.

The pen sensor 254 (e.g., a digital pen sensor), for example, may be implemented by using a method identical or similar to a method of receiving a touch input from the user, or by using a separate sheet for recognition. For example, a key pad or a touch key may be used as the keys 256. The ultrasonic input unit 258 enables the terminal to sense a sound wave by using a microphone (e.g., a microphone 288) of the terminal through a pen generating an ultrasonic signal, and to identify data. The ultrasonic input unit 258 is capable of wireless recognition. According to an embodiment of the present disclosure, the hardware may receive a user input from an external device (e.g., a network, a computer, or a server), which is connected to the communication interface 220, through the communication interface 220.

The display module 260 may include a panel 262, a hologram 264, or projector 266. The display module 260 may be, for example, the display module 160 illustrated in FIG. 1. The panel 262 may be, for example, a liquid crystal display (LCD) and an active matrix organic light emitting diode (AM-OLED) display, and the like. The panel 262 may be implemented so as to be, for example, flexible, transparent, or wearable. The panel 262 may include the touch panel 252 and one module. The hologram 264 may display a three-dimensional image in the air by using interference of light. According to an embodiment of the present disclosure, the display module 260 may further include a control circuit for controlling the panel 262 or the hologram 264.

The interface 270 may include, for example, a high-definition multimedia interface (HDMI) 272, a universal serial bus (USB) 274, an optical interface 276, and a D-subminiature (D-sub) 278. Additionally or alternatively, the interface 270 may include, for example, SD/multi-media card (MMC) (not illustrated) or infrared data association (IrDA) (not illustrated).

The audio module 280 or codec may bidirectionally convert between a voice and an electrical signal. The audio module 280 may convert voice information, which is input to or output from the audio module 280, through, for example, a speaker 282, a receiver 284, an earphone 286, the microphone 288 or the like.

The camera module 291 may capture an image and a moving image. According to an embodiment, the camera module 291 may include one or more image sensors (e.g., a front lens or a back lens), an image signal processor (ISP) (not illustrated), and a flash LED (not illustrated).

The power management module 295 may manage power of the hardware 200. Although not illustrated, the power management module 295 may include, for example, a power management integrated circuit (PMIC), a charger integrated circuit (IC), or a battery fuel gauge.

The PMIC may be mounted to, for example, an IC or a SoC semiconductor. Charging methods may be classified into a wired charging method and a wireless charging method. The charger IC may charge a battery, and may prevent an overvoltage or an overcurrent from a charger to the battery. According to an embodiment of the present disclosure, the charger IC may include a charger IC for at least one of the wired charging method and the wireless charging method. Examples of the wireless charging method may include a magnetic resonance method, a magnetic induction method, an electromagnetic method, and the like. Additional circuits (e.g., a coil loop, a resonance circuit, a rectifier, etc.) for wireless charging may be added in order to perform the wireless charging.

The battery fuel gauge may measure, for example, a residual quantity of the battery 296, or a voltage, a current or a temperature during the charging. The battery 296 may supply power by generating electricity, and may be, for example, a rechargeable battery.

The indicator 297 may indicate particular states of the hardware 200 or a part (e.g., the AP 211) of the hardware 200, for example, a booting state, a message state, a charging state and the like. The motor 298 may convert an electrical signal into a mechanical vibration. The application processor 210 may control the sensor module 240.

Although not illustrated, the hardware 200 may include a processing unit (e.g., a GPU) for supporting a module TV. The processing unit for supporting a module TV may process media data according to standards such as, for example, digital multimedia broadcasting (DMB), digital video broadcasting (DVB), media flow, and the like. Each of the above-described elements of the hardware 200 according to an embodiment of the present disclosure may include one or more components, and the name of the relevant element may change depending on the type of electronic device. The hardware according to an embodiment of the present disclosure may include at least one of the above-described elements. Some of the above-described elements may be omitted from the hardware, or the hardware may further include additional elements. Also, some of the elements of the hardware according to an embodiment of the present disclosure may be combined into one entity, which may perform functions identical to those of the relevant elements before the combination.

The term “module” used in the present disclosure may refer to, for example, a unit including one or more combinations of hardware, software, and firmware. The “module” may be interchangeable with a term, such as “unit,” “logic,” “logical block,” “component,” “circuit,” or the like. The “module” may be a minimum unit of a component formed as one body or a part thereof. The “module” may be a minimum unit for performing one or more functions or a part thereof. The “module” may be implemented mechanically or electronically. For example, the “module” according to an embodiment of the present disclosure may include at least one of an application-specific integrated circuit (ASIC) chip, a field-programmable gate array (FPGA), and a programmable-logic device for performing certain operations that have been known or are to be developed in the future.

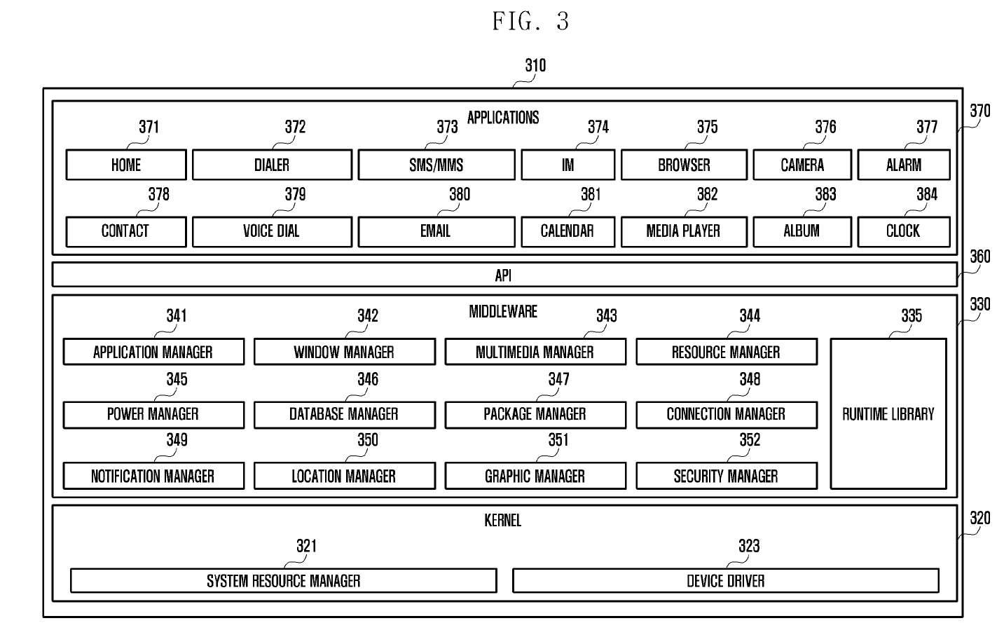

FIG. 3 illustrates a block diagram illustrating a configuration of a programming module 310 according to an embodiment of the present disclosure.

The programming module 310 may be included (or stored) in the electronic device 100 (e.g., the memory 130) or may be included (or stored) in the electronic device 201 (e.g., the memory 230) illustrated in FIG. 1. At least a part of the programming module 310 may be implemented in software, firmware, hardware, or a combination of two or more thereof. The programming module 310 may be implemented in hardware (e.g., the hardware 200), and may include an OS controlling resources related to an electronic device (e.g., the electronic device 100) and/or various applications (e.g., an application 370) executed in the OS. For example, the OS may be ANDROID, iOS, WINDOWS, SYMBIAN, TIZEN, BADA, and the like.

With reference to FIG. 3, the programming module 310 may include a kernel 320, a middleware 330, an API 360, and/or the application 370.

The kernel 320 (e.g., the kernel 141) may include a system resource manager 321 and/or a device driver 323. The system resource manager 321 may include, for example, a process manager (not illustrated), a memory manager (not illustrated), and a file system manager (not illustrated). The system resource manager 321 may perform the control, allocation, recovery, and/or the like of system resources. The device driver 323 may include, for example, a display driver (not illustrated), a camera driver (not illustrated), a BLUETOOTH driver (not illustrated), a shared memory driver (not illustrated), a USB driver (not illustrated), a keypad driver (not illustrated), a Wi-Fi driver (not illustrated), and/or an audio driver (not illustrated). Also, according to an embodiment of the present disclosure, the device driver 323 may include an inter-process communication (IPC) driver (not illustrated).

The middleware 330 may include multiple modules previously implemented so as to provide a function used in common by the applications 370. Also, the middleware 330 may provide a function to the applications 370 through the API 360 in order to enable the applications 370 to efficiently use limited system resources within the electronic device. For example, as illustrated in FIG. 3, the middleware 330 (e.g., the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and any other suitable and/or similar manager.

The runtime library 335 may include, for example, a library module used by a complier, in order to add a new function by using a programming language during the execution of the application 370. According to an embodiment of the present disclosure, the runtime library 335 may perform functions that are related to input and output, the management of a memory, an arithmetic function, and/or the like.

The application manager 341 may manage, for example, a life cycle of at least one of the applications 370. The window manager 342 may manage GUI resources used on the screen. The multimedia manager 343 may detect a format used to reproduce various media files and may encode or decode a media file through a codec appropriate for the relevant format. The resource manager 344 may manage resources, such as a source code, a memory, a storage space, and/or the like of at least one of the applications 370.

The power manager 345 may operate together with a basic input/output system (BIOS), may manage a battery or power, and may provide power information and the like used for an operation. The database manager 346 may manage a database in such a manner as to enable the generation, search and/or change of the database to be used by at least one of the applications 370. The package manager 347 may manage the installation and/or update of an application distributed in the form of a package file.

The connectivity manager 348 may manage a wireless connectivity such as, for example, Wi-Fi and Bluetooth. The notification manager 349 may display or report, to the user, an event such as an arrival message, an appointment, a proximity alarm, and the like in such a manner as not to disturb the user. The location manager 350 may manage location information of the electronic device. The graphic manager 351 may manage a graphic effect, which is to be provided to the user, and/or a user interface related to the graphic effect. The security manager 352 may provide various security functions used for system security, user authentication, and the like. According to an embodiment of the present disclosure, when the electronic device (e.g., the electronic device 100) has a telephone function, the middleware 330 may further include a telephony manager (not illustrated) for managing a voice telephony call function and/or a video telephony call function of the electronic device.

The middleware 330 may generate and use a new middleware module through various functional combinations of the above-described internal element modules. The middleware 330 may provide modules specialized according to types of OSs in order to provide differentiated functions. Also, the middleware 330 may dynamically delete some of the existing elements, or may add new elements. Accordingly, the middleware 330 may omit some of the elements described in the various embodiments of the present disclosure, may further include other elements, or may replace the some of the elements with elements, each of which performs a similar function and has a different name.

The API 360 (e.g., the API 145) is a set of API programming functions, and may be provided with a different configuration according to an OS. In the case of Android or iOS, for example, one API set may be provided to each platform. In the case of TIZEN, for example, two or more API sets may be provided to each platform.

The applications 370 (e.g., the applications 147) may include, for example, a preloaded application and/or a third party application. The applications 370 (e.g., the applications 147) may include, for example, a home application 371, a dialer application 372, a short message service (SMS)/multimedia message service (MMS) application 373, an instant message (IM) application 374, a browser application 375, a camera application 376, an alarm application 377, a contact application 378, a voice dial application 379, an electronic mail (e-mail) application 380, a calendar application 381, a media player application 382, an album application 383, a clock application 384, and any other suitable and/or similar application.

At least a part of the programming module 310 may be implemented by instructions stored in a non-transitory computer-readable storage medium. When the instructions are executed by one or more processors (e.g., the one or more processors 210), the one or more processors may perform functions corresponding to the instructions. The non-transitory computer-readable storage medium may be, for example, the memory 230. At least a part of the programming module 310 may be implemented (e.g., executed) by, for example, the one or more processors 210. At least a part of the programming module 310 may include, for example, a module, a program, a routine, a set of instructions, and/or a process for performing one or more functions.

Names of the elements of the programming module (e.g., the programming module 310) according to an embodiment of the present disclosure may change depending on the type of OS. The programming module according to an embodiment of the present disclosure may include one or more of the above-described elements. Alternatively, some of the above-described elements may be omitted from the programming module. Alternatively, the programming module may further include additional elements. The operations performed by the programming module or other elements according to an embodiment of the present disclosure may be processed in a sequential method, a parallel method, a repetitive method, or a heuristic method. Also, some of the operations may be omitted, or other operations may be added to the operations.

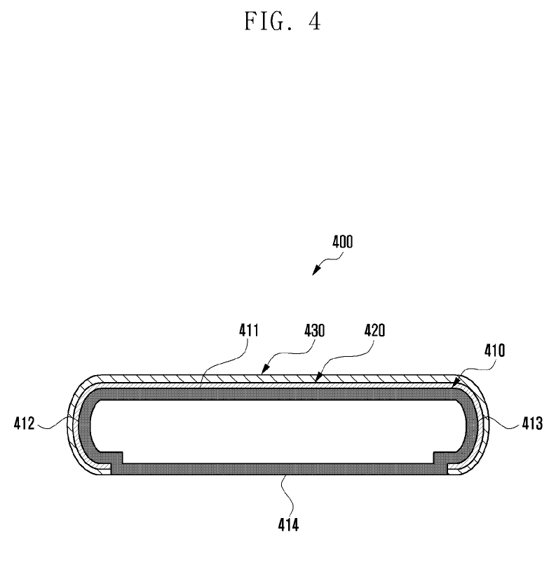

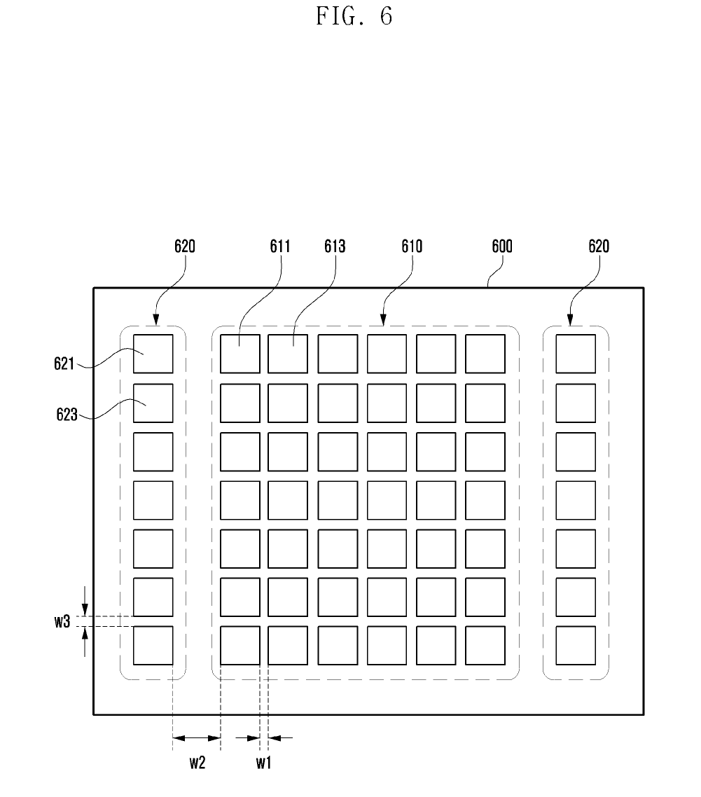

An electronic device according to various exemplary embodiments of the present disclosure may include a housing including a first surface (e.g., 411 of FIG. 4) forming an outer surface of the electronic device and a second surface (e.g., 412 of FIG. 4) of a direction different from that of the first surface; a first touch sensor (e.g., 611 of FIG. 6) and second touch sensor (e.g., 613 of FIG. 6) disposed at a first designated gap (e.g., W1 of FIG. 6) at the first surface, and at least one third touch sensor (e.g., 621 and 623 of FIG. 6) disposed at a second designated gap (e.g., W2 of FIG. 6) from the first touch sensor at the second surface. The second surface may have a form bent by a designated angle relative to the first surface. The at least one third touch sensor may include a fourth touch sensor (e.g., 621 of FIG. 6) or a fifth touch sensor (e.g., 623 of FIG. 6), and the fourth touch sensor and the fifth touch sensor may be disposed at a third designated gap. The electronic device may further include a display including a first pixel area corresponding to the first surface and a second pixel area corresponding to the second surface. The electronic device may further include a Near field communication (NFC) antenna, wherein the NFC antenna may be disposed between the first surface and the second surface. The first and second touch sensors may be configured with a self capacitance method. At least a portion of the second surface may be formed with a curved surface. The housing may be made of a material that transmits light output from the display. The electronic device may further include at least one connection wiring connected to the first touch sensor or the second touch sensor, wherein the at least one connection wiring may operate as a near field communication (NFC) antenna through a switch. The second designated gap may be larger than the first designated gap. The first and second touch sensors may be connected to a touch driving circuit through a plurality of connection wirings, and the plurality of connection wirings may be extended to a bending area between the first surface and the second surface and be bent in the bending area to be disposed along the bending area. The electronic device may further include a pressure sensor disposed at a lower portion of the first to third touch sensors and including a first electrode layer, dielectric layer, and second electrode layer, wherein in the pressure sensor, at least one selected from the first electrode layer, the dielectric layer, and the second electrode layer may be removed to form at least one groove or hole, and the at least one groove or hole may be disposed at the bending area. The NFC antenna may be formed at a layer different from that of the first and second touch sensor to be disposed to pass through a bending area between the first surface and the second surface. The switch may connect the connection wiring and a touch driving circuit in response to a touch synchronization signal and connect the connection wiring and an NFC circuit in response to an antenna synchronization signal.

Alternatively, an electronic device according to various exemplary embodiments of the present disclosure includes a housing including a first surface and a second surface of a direction different from that of the first surface; and a touch screen including a first touch sensor array disposed at the first surface and a second touch sensor array disposed at the second surface, wherein a separation distance between the first and second touch sensor arrays is different from that between touch sensors constituting the first touch sensor array. The first touch sensor array may include a plurality of first touch sensors having a length in a first direction and arranged in a second direction and a plurality of second touch sensors having a length in the second direction and arranged in the first direction, and the second touch sensor array may include a plurality of third touch sensors having a length in the first direction and arranged in the second direction and a fourth touch sensor having a length in the second direction. The number of the fourth touch sensor may be smaller than that of the second touch sensor. The plurality of second touch sensors may be separated from each other by a fourth gap, and a first or final second touch sensor and the fourth touch sensor among the plurality of second touch sensors may be separated from each other by a fifth gap. The fifth gap may be larger than the fourth gap. The electronic device may further include an NFC circuit; and an antenna connected to the NFC circuit and included in the touch screen, wherein the first and second touch sensor arrays may be connected to a touch driving circuit through a plurality of routing lines, and at least one selected from the plurality of routing lines may be connected to a switching circuit to be connected to the NFC circuit or to be connected the touch driving circuit.

FIG. 4 illustrates a cross-sectional view illustrating an electronic device according to an exemplary embodiment of the present disclosure.

With reference to FIG. 4, an electronic device 400 (e.g., the electronic device 101) according to an exemplary embodiment may include a housing 410, display 420 (e.g., the display 160), or touch screen 430. According to an exemplary embodiment, the electronic device 400 may be configured with a bended edge method. For example, the bended edge method may mean a method in which a display disposed at a front surface of the electronic device 400 is extended to a side surface thereof, as in galaxy S6 edge or galaxy S7 edge, which is a smart phone of Samsung Electronics Co., Ltd. Hereinafter, each constituent element of a described example will be described in detail.

The housing 410 may form an outer surface of the electronic device 400. For example, an outer surface of the housing 410 may include a first surface to a fourth surface 411-414. For example, the first surface 411 and the fourth surface 414 may be disposed to face, and the second surface 412 and the third surface 413 each may be disposed at both sides of the first surface 411. According to an exemplary embodiment, the first surface 411 may have a flat form, and the second surface 412 or the third surface 413 may have a form bent by a designated angle to the first surface 411. For example, the second surface 412 may have a form bent by a designated angle from one side of the first surface 411, or the third surface 413 may have a form bent by a designated angle from the other side of the first surface 411. For example, a boundary portion of the first surface 411 and the second surface 412 may be bent in a round form. Alternatively, a boundary portion of the first surface 411 and the second surface 412 may be bent without a rounded area. According to an exemplary embodiment of the present disclosure, as shown in FIG. 4, the second surface 412 and the third surface 413 may be formed in a curved surface. For example, at least a portion of the second surface 412 may be formed in a curved surface. Alternatively, at least a portion of the second surface 412 may be formed in a curved surface. According to an exemplary embodiment of the present disclosure, at least a portion of the housing 410 may be made of a material that transmits light output from the display 420.

According to an exemplary embodiment of the present disclosure, the display 420 may be configured with a flexible display. The flexible display may be a display device produced to bend using a substrate of a material having flexibility such as plastic instead of a glass substrate having no flexibility. According to an exemplary embodiment, in order to cover an outer surface of the housing 410, the display 420 may be disposed at an upper portion of the housing 410. For example, the display 420 may be disposed to cover the first surface to the third surface 411-413 of the housing 410. For example, because the second surface 412 or the third surface 413 of the housing 410 has a form bent from the first surface 411, the display 420 may cover the second surface 412 and the third surface 413 in a form bent from the first surface 411. Therefore, a screen (display area) of the display 420 may be disposed at the first surface to the third surface 411-413.

According to an exemplary embodiment of the present disclosure, the touch screen 430 may be integrally formed with the display 420 to be disposed to cover the first surface to the third surface 411-413 of the housing 410. For example, in order to cover an outer surface of the display 420, the touch screen 430 may be disposed at an upper portion of the display 420. Alternatively, the touch screen 430 may be inserted into at least one layer constituting the display 420. Alternatively, the touch screen 430 may be attached to a rear surface of cover glass (not shown) that covers an upper surface of the display 420. According to an exemplary embodiment, the touch screen 430 may cover the second surface 412 and the third surface 413 in a form bent from the first surface 411 similar to the display 420.

According to an exemplary embodiment, the touch screen 430 may be configured with a capacitance method. When a conductor such as a human body or a stylus approaches or touches the touch screen 430, the touch screen 430 of a capacitance method may detect a change in a capacitance of a touch point to recognize a touch. According to an exemplary embodiment, the touch screen 430 may be configured with a capacitance method and be configured with a mutual capacitance method or a self capacitance method (a so-called self cap method or dot matrix method). For example, the touch screen 430 according to an exemplary embodiment of the present disclosure may be configured with a mutual capacitance method and have the same structure and element as or a structure and element similar to that of the touch screen 430 disclosed at Korean Patent Laid-Open Publication No. 10-2012-0102948, Korean Patent Laid-Open Publication No. 10-2016-0092594, Korean Patent Laid-Open Publication No. 10-2013-0121447, or Korean Patent Laid-Open Publication No. 10-2015-0171680. Alternatively, the touch screen 430 according to an exemplary embodiment of the present disclosure may be configured with a magnetic capacitance method and have the same structure and element as or a structure and element similar to that of the touch screen 430 disclosed at Korean Patent Laid-Open Publication No. 10-2015-0041222 or Korean Patent Laid-Open Publication No. 10-2015-0089711.

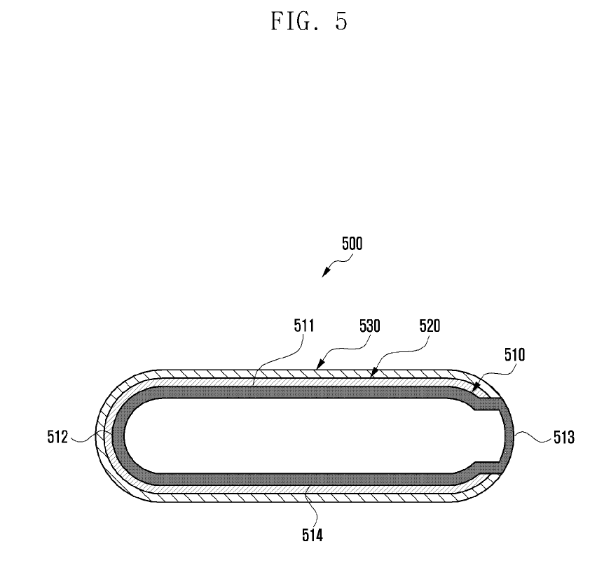

FIG. 5 illustrates a cross-sectional view illustrating an electronic device according to another exemplary embodiment of the present disclosure.

With reference to FIG. 5, an electronic device 500 (e.g., the electronic device 101) according to another exemplary embodiment may include a housing 510, a display 520 (e.g., the display 160), or a touch screen 530. According to another exemplary embodiment, the electronic device 500 may be configured with a wrap around method. For example, the electronic device 500 of a wrap around method may mean a method in which the display 520 and the touch screen 530 enclose the entire of a side surface and a rear surface as well as a front surface of the electronic device 500. For example, unlike the electronic device 400 of FIG. 4, the display 520 and the touch screen 530 of the electronic device 500 of FIG. 5 may be disposed to cover a first surface 511, a second surface 512, and a fourth surface 514 of the housing 510 and be disposed to cover at least a partial area of a third surface 513. According to an exemplary embodiment, at the third surface 513, a physical key or a physical button (not shown) for manipulating the electronic device 500 may be disposed. For example, a physical key or a physical button may be at least one volume adjustment button for adjusting a volume of an audio signal output from the electronic device 500.

FIG. 6 illustrates a top plan view illustrating a touch screen according to an exemplary embodiment of the present disclosure.

With reference to FIG. 6, a touch screen 600 (e.g., the touch screen 430) may be configured with a magnetic capacitance method. For example, the touch screen 600 may include touch sensor arrays 610 and 620 configured with a plurality of touch sensors. For example, the touch screen 600 may include a first touch sensor 611 and a second touch sensor 613 disposed to correspond to the first surface 411 of the housing 410 and separated by a first designated gap W1. Further, the touch screen 600 may include at least one third touch sensor 621 and 623 disposed to correspond to the second surface 412 of the housing 410 and disposed at a second designated gap W2 from the first touch sensor 611. According to an exemplary embodiment, at least one third touch sensor 621 and 623 may include a fourth touch sensor 621 and a fifth touch sensor 623. For example, the fourth touch sensor 621 and the fifth touch sensor 623 may be disposed at a third designated gap W3.

According to an exemplary embodiment of the present disclosure, the touch screen 600 may include a first touch sensor array 610 disposed to correspond to the first surface 411 of the housing 410 and a second touch sensor array 620 disposed to correspond to the second surface 412 or the third surface 413 of the housing 410.

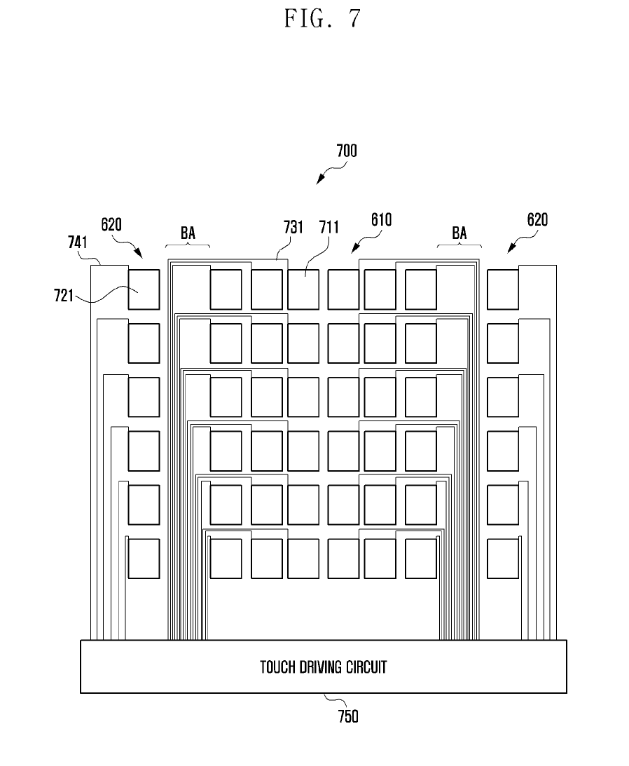

According to an exemplary embodiment of the present disclosure, the first touch sensor array 610 may include a plurality of touch sensors (touch electrodes) 611 and 613 arranged in a matrix form. Each of the touch sensors 611 and 613 of the first touch sensor array 610 may be configured with an electrode of a quadrangular form and be connected to a touch driving circuit 750 (see FIG. 7) through a connection wiring 731 (see FIG. 7). According to various exemplary embodiments of the present disclosure, the touch sensors 611 and 613 may have a form of an oval or a polygon in addition to a quadrangle. According to an exemplary embodiment, the first touch sensor array 610 may include a first touch sensor 611 and a second touch sensor 613. For example, the first touch sensor 611 and the second touch sensor 613 may be adjacent in a first direction (e.g., a horizontal direction) and be separated from each other by the first gap W1. An area of the first touch sensor 611 may be the same as that of the second touch sensor 613.

According to an exemplary embodiment of the present disclosure, the second touch sensor array 620 may include a plurality of touch sensors (touch electrodes) 621 and 623 arranged in a second direction (e.g., a vertical direction). Each of the touch sensors 621 and 623 of the second touch sensor array 620 may be configured with an electrode of a quadrangular form and be connected to the touch driving circuit 750 through a connection wiring 741 (see FIG. 7). For example, the second touch sensor array 620 may include a fourth touch sensor 621 and a fifth touch sensor 623. The fourth touch sensor 621 and the fifth touch sensor 623 may be adjacent in a second direction and be separated from each other by a third gap W3. According to an exemplary embodiment, the third gap W3 may be the same as the first gap W1.

According to an exemplary embodiment, the second touch sensor array 620 may be separated from the first touch sensor array 610 by the second gap W2. For example, the first touch sensor 611 may be disposed at an outermost edge adjacent to the second touch sensor array 620, be separated from the second touch sensor 613 by the first gap W1, and be separated from the third touch sensor 621 of the second touch sensor array 620 by the second gap W2. According to an exemplary embodiment, the second gap W2 may be larger than the first gap W1.

According to an exemplary embodiment, the first touch sensor array 610 may be disposed to correspond to the first surface 411 of the housing 410, and the second touch sensor array 620 may be disposed to correspond to the second surface 412 or the third surface 413 of the housing 410. For example, the first touch sensor array 610 may be disposed at a front surface of the electronic device 400 to detect a user touch input through a front surface of the electronic device 400, and the second touch sensor array 620 may be disposed at a side surface of the electronic device 400 to detect a user touch input through a side surface of the electronic device 400.

FIG. 7 illustrates a diagram illustrating a connection wiring of a touch screen according to an exemplary embodiment of the present disclosure.

With reference to FIG. 7, touch sensors 711 and 721 constituting first and second touch sensor arrays 610 and 620 may be connected to a touch driving circuit 750 through connection wirings 731 and 741, respectively. For example, a plurality of touch sensors 711 and 721 may be individually (independently) connected to the touch driving circuit 750 through the connection wirings 731 and 741, respectively. For example, a plurality of touch sensor 711 and 721 may be individually connected to the connection wiring 731 and 741 and be connected to the touch driving circuit 750 through the connected connection wirings 731 and 741, respectively.

According to an exemplary embodiment, a plurality of connection wirings 731 and 741 may be intensively disposed at a boundary portion of the first and second touch sensor arrays 610 and 620. Hereinafter, in a touch screen 700, a boundary portion of the first and second touch sensor arrays 610 and 620 is defined to a bending area BA. The bending area BA of the touch screen 700 is an area overlapped with a boundary portion of the first surface and second surfaces 411 and 412 of the housing 410 and may be an area in which the touch screen 700 is bent, as shown in FIG. 4 or may be an area in which the touch screen 700 is bent, as shown in FIG. 5.

According to an exemplary embodiment of the present disclosure, the first touch sensor array 610 may include a plurality of first touch sensors 711 (e.g., the first and second touch sensors 611 and 613) arranged in a matrix form, and a plurality of first touch sensors 711 may be connected to the touch driving circuit 750 through a plurality of first connection wirings 731. The plurality of first connection wirings 731 may be extended in a first direction (e.g., a horizontal direction) from a connection portion connected to the first touch sensor 711 to be connected to the bending area BA. The plurality of first connection wirings 731 extended to the bending area BA may be bent in the bending area BA and be extended in a second direction (e.g., a vertical direction) along (through) the bending area BA to be connected to the touch driving circuit 750 or a pad portion (not shown) connected to the touch driving circuit 750. For example, the pad portion may be disposed in at least one of one side edges of the touch screen 700, be connected to an end portion of the connection wirings 731 and 741, and be electrically connected to the touch driving circuit 750 by a contact with a Flexible Printed Circuit Board (FPCB).

According to an exemplary embodiment of the present disclosure, the second touch sensor array 620 includes a plurality of second touch sensors 721 (e.g., the third and fourth touch sensors 621 and 623) arranged in a second direction, and the plurality of second touch sensors 721 may be connected to the touch driving circuit 750 through a plurality of second connection wirings 741. The plurality of second connection wirings 741 may be extended in a first direction from a connection portion connected to the second touch sensor 721 to be connected to the bending area BA, which is one side of the second touch sensor array 620 or an outer edge area, which is the other side of the second touch sensor array 620. The plurality of second connection wirings 741 extended to the bending area BA or an outer edge area may be bent, be extended in a second direction (e.g., a vertical direction) along (through) the bending area BA or the outer edge area to be connected to the touch driving circuit 750 or a pad portion (not shown) connected to the touch driving circuit 750.

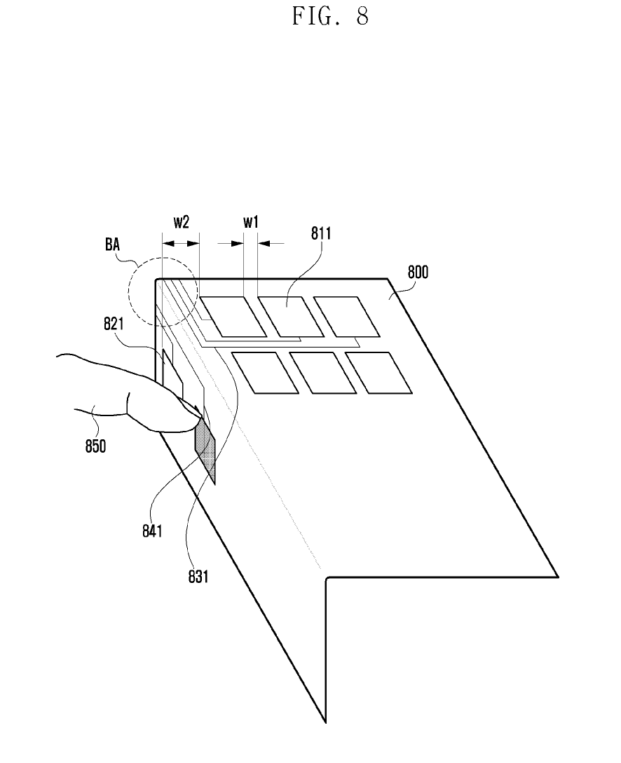

FIG. 8 illustrates a diagram illustrating a bending area of a touch screen according to an exemplary embodiment of the present disclosure.

With reference to FIG. 8, a touch screen 800 (e.g., the touch screen 430) may include a first touch sensor 811 (e.g., the first and second touch sensors 611 and 613) disposed to correspond to the first surface 411 of the housing 410 and a second touch sensor 821 (e.g., the fourth and fifth touch sensors 621 and 623) disposed to correspond to the second surface 412 of the housing 410.

According to an exemplary embodiment, neighboring first touch sensors 811 may be separated by a first gap W1, and the first touch sensor 811 and the second touch sensor 821 may be separated by a second gap W2. A boundary portion of the first and second touch sensors 811 and 821 is an area corresponding to a boundary portion of the first and second surfaces 411 and 412 of the housing 410 and may be defined to the bending area BA, as described above.

According to an exemplary embodiment of the present disclosure, a plurality of first touch sensors 811 may be connected to the touch driving circuit 750 through a plurality of first connection wirings 831. The plurality of first connection wirings 831 connected to each first touch sensor 811 may be entirely assembled in the bending area BA to be bent and be connected to the touch driving circuit 750 or the pad portion disposed at one side of the touch screen 800 along (through) the bending area BA.

According to an exemplary embodiment of the present disclosure, a plurality of second touch sensors 821 may be connected to the touch driving circuit 750 through a plurality of second connection wirings 841. The plurality of second connection wirings 841 connected to each second touch sensor 821 may be entirely assembled in the bending area BA to be bent and be connected to the touch driving circuit 750 or the pad portion disposed at an outer edge (one side) of the touch screen 800 along (through) the bending area BA.

According to various exemplary embodiments of the present disclosure, by forming a gap W2 between the first touch sensors 811 (e.g., the first and second touch sensors 611 and 613) disposed to correspond to the first surface 411 and the second touch sensor 821 (e.g., the fourth and fifth touch sensor 621 and 623 disposed to correspond to the second surface 412 to be relatively larger than a gap W1 between the first touch sensors 811, a user unintended touch input may be prevented from occurring. For example, as shown in FIG. 8, when the user touches an area corresponding to the second touch sensor 821, a gap between touch sensors is relatively enlarged in the bending area BA adjacent to a touch point; thus, an error may be prevented in which the user unintendedly performs a touch input in the bending area BA or the first surface 411 of the touch screen 800. According to an exemplary embodiment of the present disclosure, the electronic device (e.g., the electronic device 101) may display a graphical user interface (GUI), in which a user touch input is available, such as an icon at the second surface 412 in which the second touch sensor 821 is disposed, may not display a GUI, or may display a GUI unrelated to a user touch input in the bending area BA.

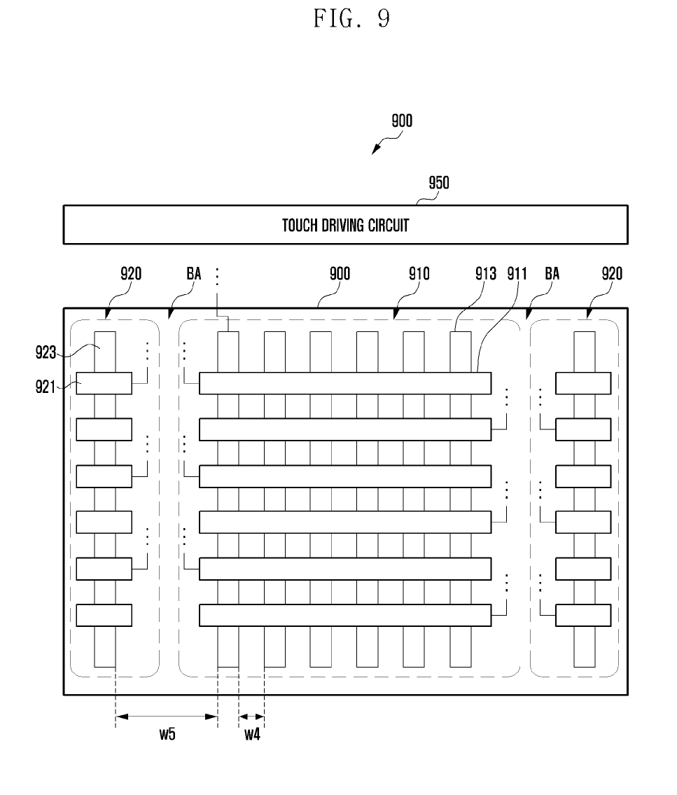

FIG. 9 illustrates a diagram illustrating a configuration of a touch screen according to another exemplary embodiment of the present disclosure.

With reference to FIG. 9, a touch screen 900 (e.g., the touch screen 430) may be configured with a mutual capacitance method. For example, the touch screen 900 may include a first touch sensor array 910 disposed to correspond to the first surface 411 of the housing 410 and a second touch sensor array 920 disposed to correspond to the second surface 412 or the fourth surface 414 of the housing 410.

According to an exemplary embodiment of the present disclosure, the first and second touch sensor arrays 910 and 920 each include intersecting touch sensors (touch electrodes), and the first and second touch sensor arrays 910 and 920 may be separated by a designated gap.

According to an exemplary embodiment of the present disclosure, the first touch sensor array 910 may include a plurality of first touch sensors 911 having a length in a first direction and arranged in a second direction and a plurality of second touch sensors 913 having a length in a second direction and arranged in a first direction. According to an exemplary embodiment, a plurality of second touch sensors 913 may be separated from each other by a fourth gap W4.

According to an exemplary embodiment of the present disclosure, the second touch sensor array 920 may include a plurality of third touch sensors 921 having a length in a first direction and arranged in a second direction and a fourth touch sensor 923 having a length in a second direction. According to an exemplary embodiment, the fourth touch sensor 923 may be configured in a single and be separated from the first (or final) second touch sensor 913 by a fifth gap W5 in the second touch sensor array 920. For example, the fifth gap W5 may be larger than the fourth gap W4. According to another exemplary embodiment, the fourth touch sensor 923 may be configured in the plural, and the number of the fourth touch sensor 923 may be smaller than that of the second touch sensor 913.

According to an exemplary embodiment, a plurality of touch sensors 911, 913, 921, and 923 constituting the first and second touch sensor arrays 910 and 920 may be connected to the touch driving circuit 950 through a connection wiring, and connection wirings connected to the first and third touch sensors 911 and 921 may be configured to assemble in the bending area BA, which is a boundary portion of the first and second touch sensor arrays 910 and 920.

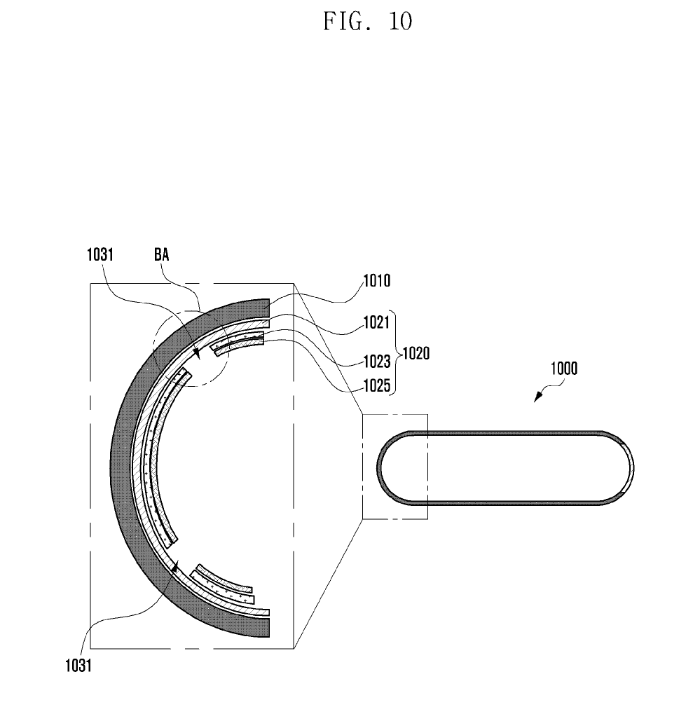

FIG. 10 illustrates an enlarged cross-sectional view illustrating a portion of an electronic device according to various exemplary embodiments of the present disclosure. Specifically, FIG. 10 is an enlarged cross-sectional view illustrating a bending area of an electronic device according to various exemplary embodiments of the present disclosure.

With reference to FIG. 10, an electronic device 1000 (e.g., the electronic device 400) according to various exemplary embodiments of the present disclosure may include a display 1010 (e.g., the display 420) including the touch screen (e.g., the touch screen 430) and a pressure sensor 1020 attached to a lower surface of the display 1010.

According to an exemplary embodiment of the present disclosure, the display 1010 may include a touch screen, and the touch screen may have the same configuration as or a configuration similar to that of at least one of touch screens of FIGS. 4 to 9.

According to an exemplary embodiment of the present disclosure, the pressure sensor 1020 may include a first electrode layer 1021, dielectric layer 1023, and second electrode layer 1025. According to an exemplary embodiment, at least a portion of the pressure sensor 1020 may be patterned in the bending area BA in which the touch screen and the display are bent. For example, in the bending area BA, at least a portion of the dielectric layer 1023 and the second electrode layer 1025 may be patterned (removed); thus, at least one groove 1031 that exposes a lower surface of the first electrode layer 1021 may be formed.

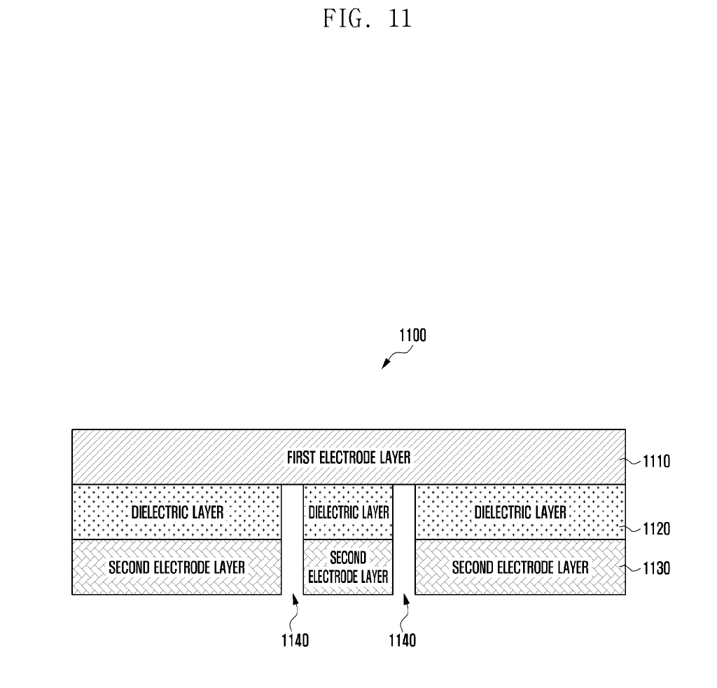

FIG. 11 is a cross-sectional view illustrating a pressure sensor according to an exemplary embodiment of the present disclosure.

With reference to FIG. 11, a pressure sensor 1100 includes a first electrode layer 1110 in which a first electrode is arranged, a dielectric layer 1120 formed at a lower portion of the first electrode layer 1110, and a second electrode layer 1130 formed at a lower portion of the dielectric layer 1120 and in which a second electrode is arranged. In the dielectric layer 1120, at least one spacer (not shown) for maintaining a gap of the first electrode and the second electrode may be formed. The dielectric layer 1120 may be made of a pressure conductivity variable material.

According to an exemplary embodiment, at least a portion of the pressure sensor 1100 may be patterned in a bending area BA in which a touch screen (e.g., the touch screen 430) and a display (e.g., the display 420) are bent. For example, in the bending area BA, at least a portion of the dielectric layer 1120 and the second electrode layer 1130 is patterned (removed); thus, at least one groove 1140 that exposes a lower surface of the first electrode layer 1021 may be formed. Alternatively, the pressure sensor 1100 may include at least hole formed by simultaneously patterning of the first electrode layer 1110, the dielectric layer 1120, and the second electrode layer 1130, and the hole may be disposed at the bending area BA in which the touch screen and the display are bent.

The pressure sensor 1100 according to various exemplary embodiments of the present disclosure may have the same configuration as or a configuration similar to that of a pressure sensor in the art. For example, the pressure sensor 1020 according to various exemplary embodiments of the present disclosure may have the same configuration as or a configuration similar to that of a pressure sensor disclosed at Korean Patent Laid-Open Publication No. 10-2016-0039767 or Korean Patent Laid-Open Publication No. 10-2014-0078922.

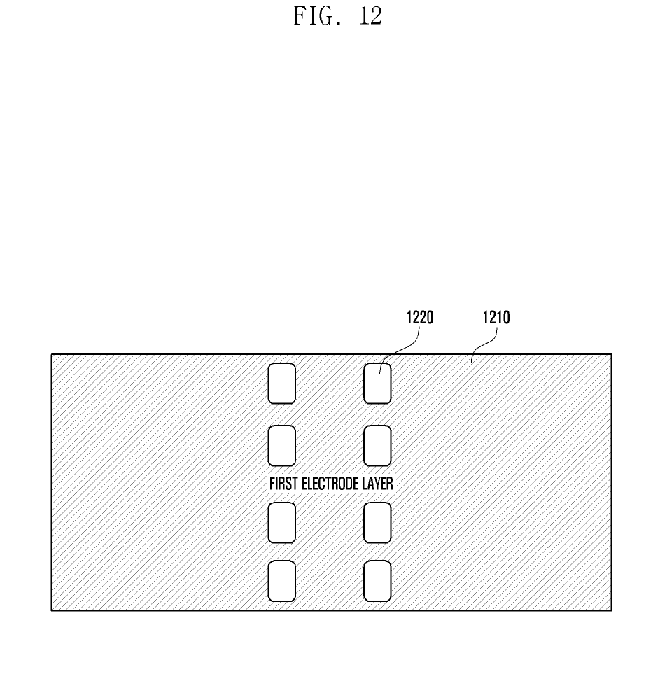

FIG. 12 illustrates a top plan view illustrating a first electrode layer of a pressure sensor according to an exemplary embodiment of the present disclosure.

With reference to FIG. 12, a first electrode layer 1210 (e.g., the first electrode layer 1110) of a pressure sensor (e.g., the pressure sensor 1100) may be patterned at the same position as that of the dielectric layer 1120 and the second electrode layer 1130; thus, a hole 1220 may be formed. According to an exemplary embodiment, the hole 1220 of the first electrode layer 1210 may be disposed at a bending area BA in which the touch screen and the display are bent and be configured with a plurality of holes separated by a designated gap in the bending area BA.

In various exemplary embodiments of the present disclosure, by disposing the pressure sensor 1020 at a rear surface of the display 1010 including a touch screen, and by patterning the dielectric layer 1023 of the pressure sensor 1020 and at least a portion of the second electrode layer 1025 in the bending area BA in which the touch screen and the display are bent, the electronic device 1000 may prevent a user from performing unintended pressure sensing in the bending area BA.

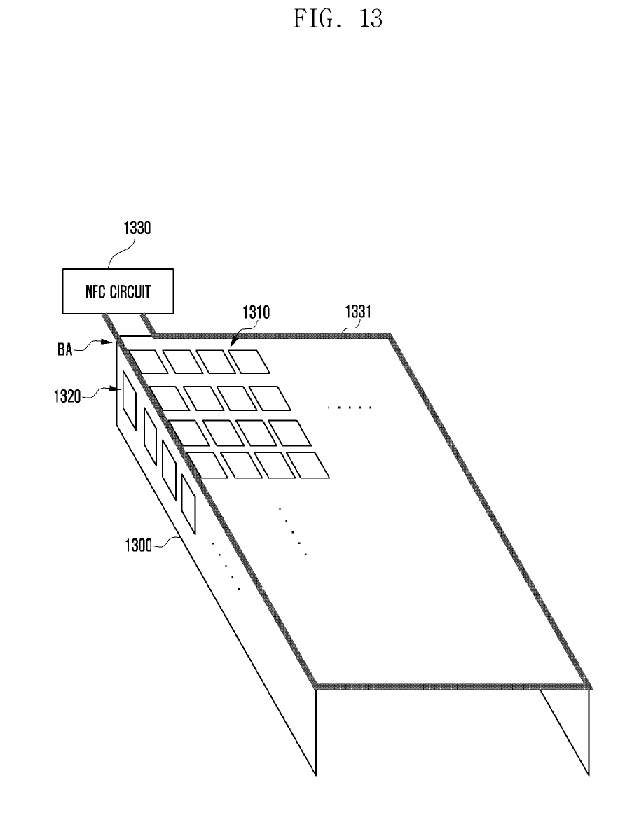

FIG. 13 illustrates a diagram illustrating an antenna formed in a touch screen according to an exemplary embodiment of the present disclosure.

With reference to FIG. 13, a touch screen 1300 (e.g., the touch screen 430) may be configured with a magnetic capacitance method and have the same configuration as or a configuration similar to that of at least one of the touch screens of FIGS. 6 to 8.

For example, the touch screen 1300 may include a first touch sensor 1310 (e.g., the first and second touch sensors 611 and 613) disposed to correspond to the first surface 411 of the housing 410 and a second touch sensor 1320 (e.g., the third and fourth touch sensors 621 and 623) disposed to correspond to the second surface 412 of the housing 410.

According to an exemplary embodiment, a boundary portion of the first and second touch sensors 1310 and 1320 is an area corresponding to a boundary portion of the first and second surfaces 411 and 412 of the housing 410, and as shown in FIG. 8, a plurality of connection wirings (not shown) connected to the first and second touch sensors 1310 and 1320 may be assembled.

In various exemplary embodiments of the present disclosure, an antenna 1331 for short range communication, for example, NFC communication may be formed using the bending area BA in which a touch sensor is not disposed and in which a plurality of connection wirings are intensively disposed. For example, in the touch screen 1300, an antenna 1331 of a form enclosing an outer edge of the first surface 411 of the housing 410 may be formed, and the antenna 1331 may be formed to pass through the bending area BA through a layer different from that of the touch sensor. In an exemplary embodiment of the present disclosure, by forming an antenna for short range communication using the bending area BA of the touch screen, a problem can be solved that an antenna mounting space is reduced according to extension of a display space.

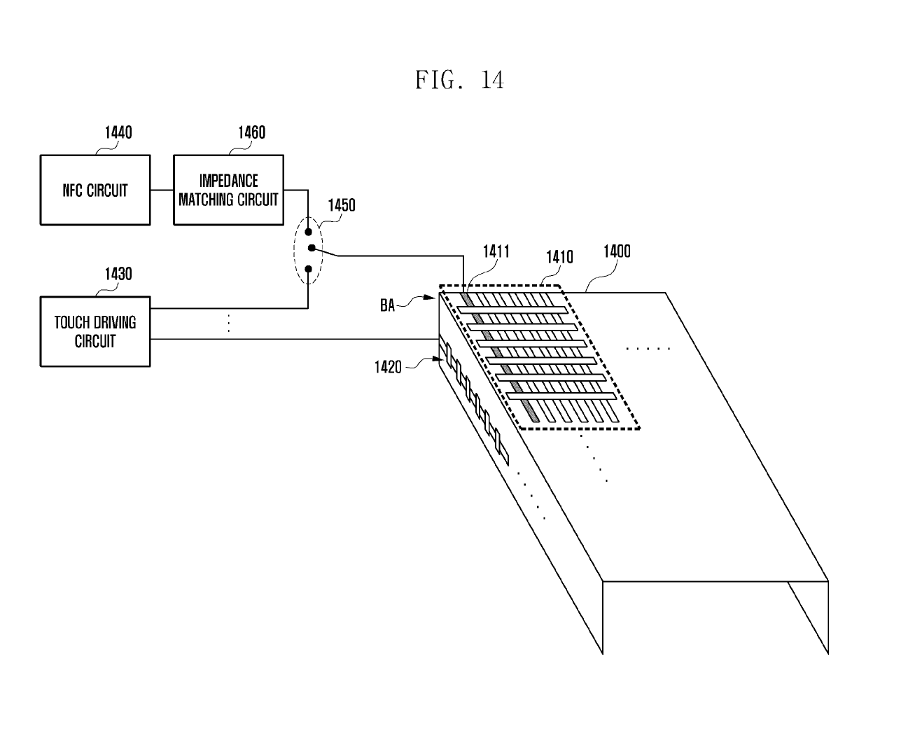

FIG. 14 illustrates a diagram illustrating an example of using a portion of a touch screen as an antenna according to an exemplary embodiment of the present disclosure.

With reference to FIG. 14, a touch screen 1400 (e.g., the touch screen 430) may be configured with a mutual capacitance method. For example, the touch screen 1400 may include a first touch sensor array 1410 disposed to correspond to the first surface 411 of the housing 410 and a second touch sensor array 1420 disposed to correspond to the second surface 412 or a fourth surface 414 of the housing 410.

According to an exemplary embodiment of the present disclosure, the first and second touch sensor arrays 1410 and 1420 each include intersecting touch sensors (touch electrodes), and the first and second touch sensor arrays 910 and 920 may be separated by a designated gap.

According to an exemplary embodiment of the present disclosure, the first and second touch sensor arrays 1410 and 1420 may include a plurality of touch sensors 1411 having a length in a second direction (e.g., a vertical direction) and arranged in a first direction. The electronic device according to an exemplary embodiment may use at least one touch sensor 1411 having a length in a second direction (e.g., a vertical direction) as an antenna for short range communication, for example, NFC communication.

For example, at least one selected from a plurality of touch sensors 1411 having a length in a second direction (e.g., a vertical direction) may be used as a touch sensor in a touch sensing period and be used as an antenna in an antenna driving period. For example, in FIG. 14, a touch sensor designated by reference numeral 1411 may be connected to a switching circuit 1450 through a connection wiring. According to an exemplary embodiment, the switching circuit 1450 may connect the touch sensor 1411 and a touch driving circuit 1430 in response to a touch synchronization signal and connect the touch sensor 1411 and an NFC circuit 1440 in response to an antenna synchronization signal.

According to an exemplary embodiment, an impedance matching circuit 1460 may be disposed between the NFC circuit 1440 and the switching circuit 1450. The impedance matching circuit 1460 may be configured to match impedance between the NFC circuit 1440 and the touch sensor 1411. For example, the impedance matching circuit 1460 may be a lumped element and include at least one of a register, inductor, and capacitor.

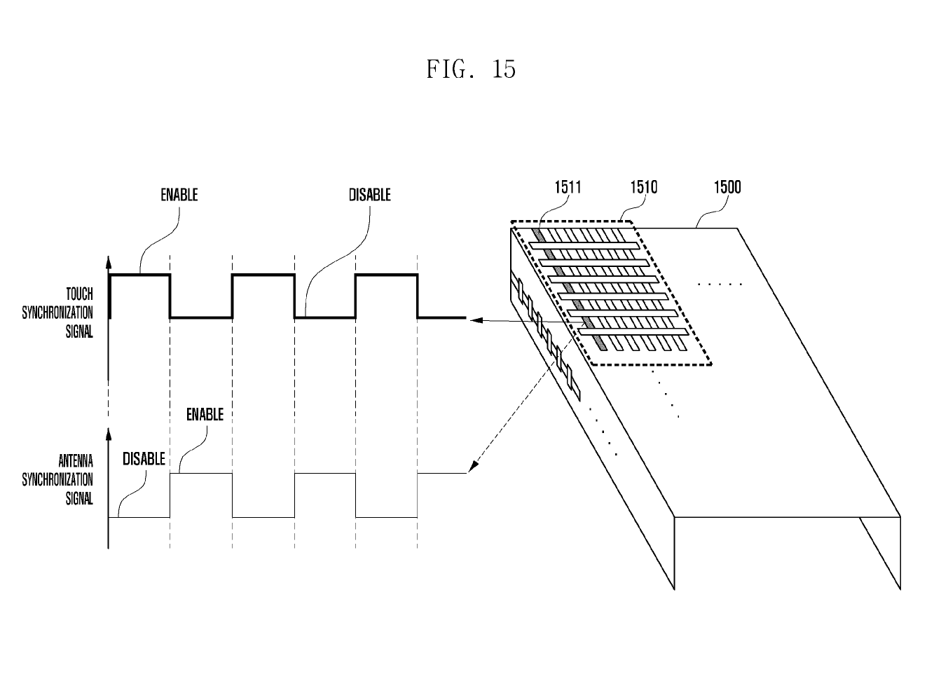

FIG. 15 illustrates a diagram illustrating driving timing of a touch screen according to an exemplary embodiment of the present disclosure.

With reference to FIG. 15, a touch screen 1500 (e.g., the touch screen 430) may be configured with a mutual capacitance method and include the same configuration as or a configuration similar to that of the touch screen 1400 of FIG. 14.

For example, the touch screen 1500 may include a first touch sensor array 1510 disposed to correspond to the first surface 411 of the housing 410. The first touch sensor array 1510 may include a plurality of touch sensors 1511 having a length in a second direction (e.g., a vertical direction). According to an exemplary embodiment, at least one selected from a plurality of touch sensors 1511 may be used as a touch sensor in a touch sensing period and may be used as an antenna in an antenna driving period. For example, in FIG. 15, a connection wiring connected to a touch sensor designated by reference numeral 1511 may be connected to a switching circuit (e.g., the switching circuit 1450) to be connected to the NFC circuit 1440 or the touch driving circuit 1430.

According to an exemplary embodiment, the switching circuit 1450 connects the touch sensor 1411 and the touch driving circuit 1430 in response to a touch synchronization signal; thus, the touch sensor 1511 may perform a function of a Tx electrode or an Rx electrode in a touch screen of a mutual capacitance method. In a period in which a touch synchronization signal is enabled, an antenna synchronization signal may be disabled.

Alternatively, the switching circuit 1450 connects the touch sensor 1411 and the NFC circuit 1440 in response to an antenna synchronization signal; thus, the touch sensor 1511 may perform a function of an NFC antenna instead of a function of a Tx electrode or an Rx electrode of the touch screen. In a period in which an antenna synchronization signal is enabled, a touch synchronization signal may be disabled.

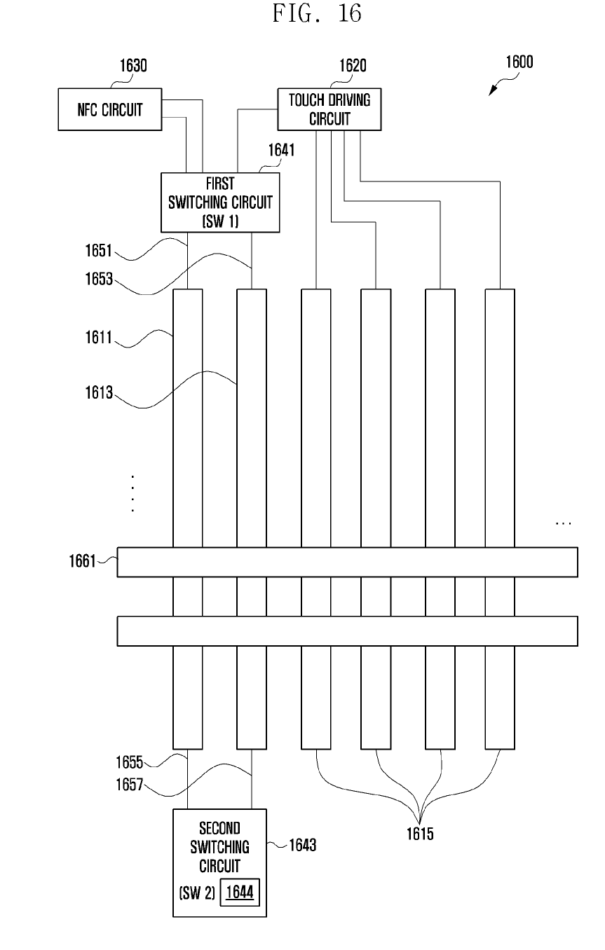

FIG. 16 illustrates a diagram illustrating an example of using a portion of a touch screen as an antenna according to an exemplary embodiment of the present disclosure.

With reference to FIG. 16, a touch screen 1600 (e.g., the touch screen 430) may be configured with a mutual capacitance method and include the same configuration or a configuration similar to that of the touch screen 1400 of FIG. 14.

For example, the touch screen 1600 may include first and second touch sensors 1611 and 1613 having a length in a second direction (e.g., a vertical direction) and separated by a designated gap, a plurality of third touch sensors 1615 arranged parallel to the first and second touch sensors 1611 and 1613, and a plurality of fourth touch sensor 1661 intersecting the first and second touch sensors 1611 and 1613. A plurality of third and fourth touch sensors 1615 and 1661 may be directly connected to a touch driving circuit 1620 through a connection wiring connected thereto.

According to an exemplary embodiment, the first and second touch sensors 1611 and 1613 may be connected to first connection wirings 1651 and 1653 at one side (e.g., upper portion) and be connected to a first switching circuit 1641 through the first connection wirings 1651 and 1653. Further, the first and second touch sensors 1611 and 1613 may be connected to second connection wirings 1655 and 1657 at the other side (e.g., lower portion) and be connected to a second switching circuit 1643 through the second connection wirings 1655 and 1657.

According to an exemplary embodiment of the present disclosure, the first switching circuit 1641 may be switched in response to an antenna synchronization signal or a touch synchronization signal and may connect the first connection wirings 1651 and 1653 and an NFC circuit 1630 or connect the first connection wirings 1651 and 1653 and the touch driving circuit 1620. For example, the first switching circuit 1641 may connect the first connection wirings 1651 and 1653 and the NFC circuit 1630 in response to an antenna synchronization signal. Alternatively, the first switching circuit 1641 may connect the first connection wirings 1651 and 1653 and the touch driving circuit 1620 in response to a touch synchronization signal.

According to an exemplary embodiment of the present disclosure, the second switching circuit 1643 may be switched in response to an antenna synchronization signal and connect the second connection wirings 1655 and 1657 connected to the first and second touch sensors 1611 and 1613. According to an exemplary embodiment, when the second switching circuit 1643 connects the second connection wirings 1655 and 1657 connected to the first and second touch sensors 1611 and 1613 in response to an antenna synchronization signal, the second switching circuit 1643 may include a compensation element 1644 for compensating an emission characteristic of the antenna, for example, a length characteristic of the antenna. The compensation element 1644 may include at least one selected from, for example, a register, inductor, and capacitor.

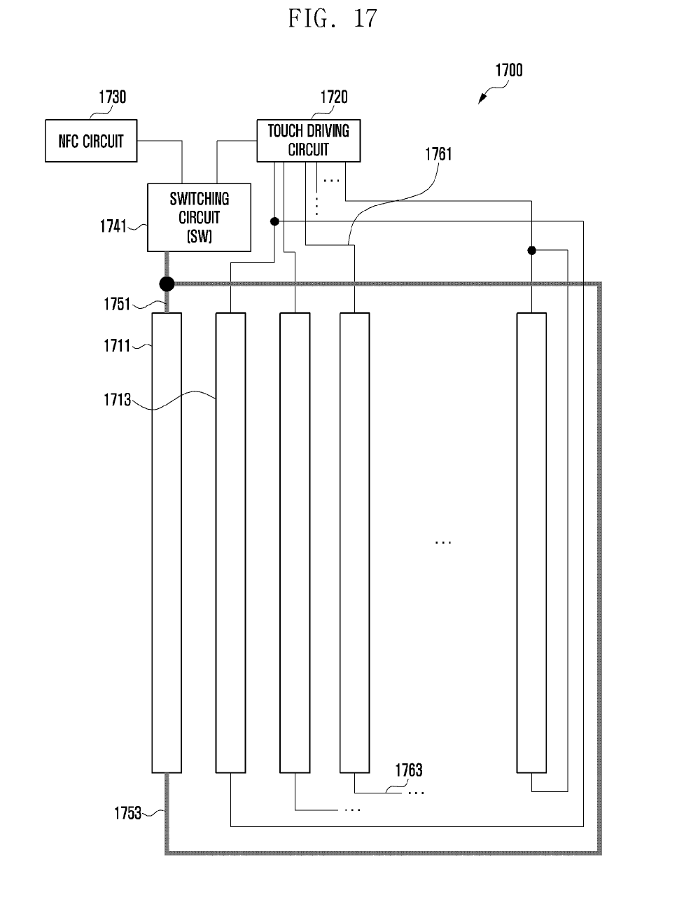

FIG. 17 illustrates a diagram illustrating an example of using a portion of a touch screen as an antenna according to another exemplary embodiment of the present disclosure.

With reference to FIG. 17, a touch screen 1700 may be configured with a mutual capacitance method and include the same configuration as or a configuration similar to that of the touch screen 1400 of FIG. 14.

According to an exemplary embodiment of the present disclosure, the touch screen 1700 may include a first touch sensor 1711 having a length in a second direction (e.g., a vertical direction) and separated by a designated gap, a plurality of second touch sensors 1713 arranged parallel to the first touch sensor 1711, and a plurality of third touch sensors (not shown) intersecting the first and second touch sensors 1711 and 1713.

According to an exemplary embodiment of the present disclosure, in the touch screen 1700, unlike the touch screen 1600 of FIG. 16, the first and second touch sensors 1711 and 1713 each having a length in a second direction may be connected to a connection wiring at both sides. For example, the first touch sensor 1711 may be connected to a first connection wiring 1751 at one side (e.g., upper portion), be connected to a second connection wiring 1753 at the other side (e.g., lower portion), and the second connection wiring 1753 may be extended to one side of the first touch sensor 1711 while enclosing an outer edge of a touch sensor array to be connected to the first connection wiring 1751. Alternatively, the second touch sensor 1713 may be connected to a third connection wiring 1761 at one side and be connected to a fourth connection wiring 1763 at the other side, and the fourth connection wiring 1763 may be extended to one side of the second touch sensor 1713 while enclosing an outer edge of a touch sensor array to be connected to the third connection wiring 1761.

According to an exemplary embodiment, the first and second connection wirings 1751 and 1753 connected to the first touch sensor 1711 may be connected to a switching circuit 1741, and the third and fourth connection wirings 1761 and 1763 connected to the second touch sensor 1713 may be connected to a touch driving circuit 1720.

According to an exemplary embodiment of the present disclosure, the switching circuit 1741 may be switched in response to an antenna synchronization signal or a touch synchronization signal, connect the first and second connection wirings 1751 and 1753 and an NFC circuit 1730 or connect the first and second connection wirings 1751 and 1753 and the touch driving circuit 1720. For example, the switching circuit 1741 may connect the first and second connection wirings 1751 and 1753 and the NFC circuit 1730 in response to an antenna synchronization signal. Alternatively, the switching circuit 1741 may connect the first and second connection wirings 1751 and 1753 and the touch driving circuit 1720 in response to a touch synchronization signal.

As described above, according to various exemplary embodiments of the present disclosure, in an area in which a touch screen and a display are bent, user unintended touch detection and pressure detection can be prevented from occurring.

A programming module according to embodiments of the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device, comprising:
a housing including a first surface forming an outer surface of the electronic device and a second surface of a direction different from that of the first surface; and
a first touch sensor and second touch sensor disposed at a first designated gap at the first surface, and at least one third touch sensor disposed at a second designated gap from the first touch sensor at the second surface.

2. The electronic device of claim 1, wherein the second surface has a form bent by a designated angle relative to the first surface.

3. The electronic device of claim 1, wherein the at least one third touch sensor includes a fourth touch sensor or a fifth touch sensor, wherein the fourth touch sensor and the fifth touch sensor are disposed at a third designated gap.

4. The electronic device of claim 1, further comprising a display including a first pixel area corresponding to the first surface and a second pixel area corresponding to the second surface.

5. The electronic device of claim 1, further comprising a near field communication (NFC) antenna,
wherein the NFC antenna is disposed between the first surface and the second surface.

6. The electronic device of claim 5, wherein the NFC antenna is formed at a layer different from that of the first and second touch sensor to be disposed to pass through a bending area between the first surface and the second surface.

7. The electronic device of claim 1, wherein the first and second touch sensors are configured with a self capacitance method.

8. The electronic device of claim 1, wherein at least a portion of the second surface is formed in a curved surface.

9. The electronic device of claim 1, wherein the housing is made of a material that transmits light output from a display.

10. The electronic device of claim 1, further comprising at least one connection wiring connected to the first touch sensor or the second touch sensor,
wherein the at least one connection wiring operates as an NFC antenna through a switch.

11. The electronic device of claim 10, wherein the switch connects the connection wiring and a touch driving circuit in response to a touch synchronization signal and connects the connection wiring and an NFC circuit in response to an antenna synchronization signal.

12. The electronic device of claim 1, wherein the second designated gap is larger than the first designated gap.

13. The electronic device of claim 1, wherein the first and second touch sensors are connected to a touch driving circuit through a plurality of connection wirings, and
wherein the plurality of connection wirings are disposed at a bending area between the first surface and the second surface.

14. The electronic device of claim 13, further comprising a pressure sensor disposed at a lower portion of the first to third touch sensors, a first electrode layer, dielectric layer, and second electrode layer,
wherein in the pressure sensor, at least one selected from the first electrode layer, the dielectric layer, and the second electrode layer is removed to form at least one groove or hole, and
wherein the at least one groove or hole is disposed at the bending area.

15. An electronic device, comprising:
a housing including a first surface and a second surface of a direction different from that of the first surface; and
a touch screen including a first touch sensor array disposed at the first surface and a second touch sensor array disposed at the second surface,
wherein a separation distance between the first and second touch sensor arrays is different from that between touch sensors constituting the first touch sensor array.

16. The electronic device of claim 15, wherein the first touch sensor array includes a plurality of first touch sensors having a length in a first direction and arranged in a second direction and a plurality of second touch sensors having a length in the second direction and arranged in the first direction, and
the second touch sensor array includes a plurality of third touch sensors having a length in the first direction and arranged in the second direction and a fourth touch sensor having a length in the second direction.

17. The electronic device of claim 16, wherein a number of the fourth touch sensor is smaller than that of the second touch sensor.

18. The electronic device of claim 16, further comprising:
a near field communication (NFC) circuit; and
an antenna connected to the NFC circuit and included in the touch screen,
wherein the first and second touch sensor arrays are connected to a touch driving circuit through a plurality of routing lines, and
at least one selected from the plurality of routing lines is connected to a switching circuit to be connected to the NFC circuit or to be connected to the touch driving circuit.

19. The electronic device of claim 16, wherein the plurality of second touch sensors are separated from each other by a fourth gap, and
a first or final second touch sensor and the fourth touch sensor among the plurality of second touch sensors are separated from each other by a fifth gap.

20. The electronic device of claim 19, wherein the fifth gap is larger than the fourth gap.
